(19) United States
(12) Patent Application Publication
(10) Pub. No.: US 2025/0276482 A1
(43) Pub. Date: Sep. 4, 2025

(54) Equipment for Preparing Polyethylene Coating with Three-Layer Structure Wound on Steel Elbow

(71) Applicant: Wuxi Zhongyou Ruide Anticorrosion Technology Co.Ltd, Wuxi City (CN)

(72) Inventors: Ruixiang YU, Wuxi City (CN); Yao ZHANG, Wuxi City (CN)

(73) Assignee: Wuxi Zhongyou Ruide Anticorrosion Technology Co.Ltd, Wuxi City (CN)

(21) Appl. No.: 19/186,657

(22) Filed: Apr. 23, 2025

Related U.S. Application Data
(63) Continuation-in-part of application No. PCT/CN2024/139994, filed on Dec. 17, 2024.

(30) Foreign Application Priority Data
Feb. 29, 2024 (CN) 202410230075.2

(51) Int. Cl. B29C 48/025; B29C 48/151; B29C 48/92; B29K 705/12; B29L 23/00

(52) U.S. Cl. CPC B29C 48/025; B29C 48/151; B29C 48/92; B29C 2948/92019; B29C 2948/92209; B29C 2948/92514; B29C 2948/92704; B29K 2023/04; B29K 2705/12; B29L 2023/22

(57) ABSTRACT

The present disclosure discloses equipment for preparing a polyethylene coating with a three-layer structure wound on a steel elbow, belonging to the technical field of anti-corrosion pipe production equipment. The equipment including a material conveying mold for conveying molten polyethylene, the material conveying mold includes a static mold and a rotary mold which are rotationally connected, and a first material conveying channel is formed in the static mold, a second material conveying channel is formed in the rotary mold, a material outlet port of the first material conveying channel is coaxially communicated with a material inlet port of the second material conveying channel, a first sealing structure and a second sealing structure are arranged at the communication position around the axis from inside to outside at intervals, the first sealing structure is made of wear-resistant materials, and the second sealing structure is sealed by high-temperature gas.

### CROSS-REFERENCE TO RELATED APPLICATION

This patent application is a continuation-in-part of PCT Application No. PCT/CN2024/139994 filed Dec. 17, 2024, and claims the benefit and priority of Chinese Patent Application No. 202410230075.2, entitled “EQUIPMENT FOR PREPARING POLYETHYLENE COATING WITH THREE-LAYER STRUCTURE WOUND ON STEEL ELBOW” filed with the China National Intellectual Property Administration on Feb. 29, 2024, the disclosure of which is incorporated by reference herein in its entirety as part of the present application.

### TECHNICAL FIELD

The present disclosure relates to the technical field of anti-corrosion pipe production equipment, in particular to equipment for preparing a polyethylene coating with a three-layer structure wound on a steel elbow

### BACKGROUND

At present, the external anti-corrosion coating of long-distance oil and gas pipelines is an important barrier to ensure the safety of pipelines. Among them, the commonly used 3LPE anti-corrosion steel pipe is a three-layer polyethylene composite structure processed on the outside of the steel pipe as an anti-corrosion coating. At present, the straight pipe processing technology for existing 3LPE anti-corrosion steel pipes has matured, and the hot extrusion winding technology or the hot extrusion coating technology is mostly used to complete the processing of the anti-corrosion coating. However, there are still some problems with the anti-corrosion coating processing for the elbow. For example, in the 3PE hot extrusion circumferential winding forming method for the steel elbow disclosed in the patent CN105666843A, it is mentioned that before coating, the plunger extruder is butted to the single screw extruder through a quick connection device in advance, and the melted polyethylene in the single screw extruder is injected into the plunger extruder with its own insulation device. Then, the quick connection device is disconnected, and the plunger extruder is driven by a reducer to rotate on a circular track and extrude the polyethylene strip for hot winding onto the surface of the adhesive intermediate layer of the elbow. This processing method cannot achieve continuous winding operation and molten polyethylene raw materials need to be supplied intermittently in the process, which is cumbersome to operate and has low work efficiency; and the anti-corrosive coating with intermittent points also has a hidden danger of leakage.

In order to solve the above problems, the applicant mentioned that, in the patent CN115230111A, a 3LPE anti-corrosion steel pipe winding device includes an extruder and a worktable, the extruder is connected to the worktable through a rotating mechanism, the discharge end of the extruder is connected to the annular flow channel, and the discharge pipe of the extruder is connected to the inner cavity of the annular flow channel. The inner ring of the annular flow channel is sprayed with molten polyethylene in the circumferential direction towards the outer wall of the elbow body through a winding mechanism. The forward direction of the annular flow channel is equipped with a preheating spraying mechanism on one side and a roller pressing mechanism on the other side. The elbow body is place on the worktable, the extruder and its end annular flow channel are driven by the rotating mechanism to rotate along the radian of the elbow body, the preheating spraying mechanism is used for spraying fusion bon FBE on the outer wall of the elbow body in advance, molten polyethylene in the extruder is spirally sprayed on the circumferential direction of the elbow body through the winding mechanism, and a 3LPE coating is formed by compacting through the rolling mechanism. The device realizes the continuous spraying for polyethylene, improves the working efficiency, and can ensure the processing quality of the 3LPE anticorrosive steel pipes.

However, in the subsequent practical work process, the applicant found that the sealing between the inner rings and the outer rings was insufficient, and the polyethylene in a high-temperature and high-pressure fluid state was prone to overflow, resulting in insufficient polyethylene output and seriously affecting the effective continuous spraying process, while also causing significant waste.

### SUMMARY

The present disclosure provides equipment for preparing a polyethylene coating with a three-layer structure wound on a steel elbow, which realizes the technical purpose of preventing polyethylene in a high-temperature and high-pressure fluid state from overflowing on the basis of a multiple sealing structure.

In order to achieve the above effects, the present disclosure provides equipment for preparing a polyethylene coating with a three-layer structure wound on a steel elbow, including: a material conveying mold for conveying molten polyethylene, the material conveying mold includes a static mold and a rotary mold which are rotationally connected, and a first material conveying channel is formed in the static mold, a second material conveying channel is formed in the rotary mold, a material outlet port of the first material conveying channel is coaxially communicated with a material inlet port of the second material conveying channel, a first sealing structure and a second sealing structure are arranged at the communication position around the axis from inside to outside at intervals, the first sealing structure is made of wear-resistant materials, and the second sealing structure is sealed by high-temperature gas.

Preferably, the static mold is provided with a driving motor, which is connected to the rotary mold through a transmission component and used to drive the rotary mold to rotate relative to the static mold.

Preferably, the transmission component adopts gear transmission, and the output shaft of the driving motor drives the driving gear to rotate, the driving gear drives the rotary mold meshed with the driving gear to rotate.

Preferably, a rotating support protrusion is provided on the outer end surface of the material outlet port of the first material conveying channel, and a rotating support groove is provided on the outer end surface of the material inlet port of the second material conveying channel. The rotating support protrusion can be inserted into the rotating support groove, and the first sealing structure is provided inside the rotating support groove.

Preferably, a first gas containment cavity is provided on the outer end surface of the material outlet port of the first material conveying channel, and a second gas containment cavity is provided on the outer end surface of the material inlet port of the second material conveying channel. The first gas containment cavity and the second gas containment cavity are arranged relative to each other to form a high-temperature gas sealing cavity, which is connected to a high-temperature gas source.

Preferably, an L-shaped labyrinth sealing structure is formed among the rotating support protrusion, the high-temperature gas sealing cavity and the rotating support groove.

Preferably, a temperature sensor is provided inside the high-temperature gas sealing cavity; if the temperature detection value is greater than the preset temperature value, the input temperature of the high-temperature gas source is reduced; if the temperature detection value is less than the preset temperature value and the temperature detection valve is greater than 0.8 times of the preset temperature value, heating wires in the first gas containment cavity and the second gas containment cavity are started; if the temperature detection value is less than 0.8 times of the preset temperature value, the input temperature of the high-temperature gas source is increased.

Preferably, a gas pressure sensor is provided inside the high-temperature gas sealing cavity; if the gas pressure detection value is greater than the preset gas pressure value, the input amount of the high-temperature gas source is reduced; if the gas pressure detection value is less than the preset gas pressure value and the gas pressure detection value is greater than 0.9 times of the preset gas pressure value, heating wires in the first gas containment cavity and the second gas containment cavity are started; if the gas pressure detection value is less than 0.9 times of the preset temperature value, the input amount of the high-temperature gas source is increased.

Preferably, the equipment further includes a worktable for supporting the elbow body and the extruder, wherein the extruder body is rotatably connected to the worktable through a rotating mechanism, and the material output end of the extruder is connected to the material inlet port of the first material conveying channel, the rotating mechanism is used to drive the extruder and a material conveying mold at the end of the extruder to rotate along the radian of the elbow body; the material outlet port of the second material conveying channel is connected to the pressure accumulation storage bin, and the pressure accumulation storage bin is fixedly connected to the rotary mold; the material output end of the pressure accumulation storage bin is provided with a polyethylene rolling mechanism; the polyethylene rolling mechanism includes a connected rotating motor and the calender roll.

Compared with the prior art, the present disclosure has achieved the following beneficial effects.

The method of setting a high-temperature gas sealing structure on the outer side of the first sealing structure with wear-resistant material ensures that polyethylene in a high-temperature and high-pressure fluid state does not overflow, solving the problem of insufficient sealing between the inner ring and the outer ring, so that the problem that effective continuous spraying is seriously influenced by insufficient polyethylene output is avoided, and meanwhile, the problem of waste caused by leakage is also avoided.

### BRIEF DESCRIPTION OF THE DRAWINGS

In order to more clearly illustrate the embodiments of the present disclosure or technical solutions in the related art, the accompanying drawings used in the embodiments will now be described briefly. It is obvious that the drawings in the following description are only the embodiment of the disclosure, and that those skilled in the art can obtain other drawings from these drawings without any creative efforts.

FIG. 1 is a structural schematic diagram of equipment for preparing a polyethylene coating with a three-layer structure wound on a steel elbow;

FIG. 2 is a state change diagram of FIG. 1;

FIG. 3 is the structural diagram (I) of the material conveying mold;

FIG. 4 is the structural diagram (II) of the material conveying mold; and

FIG. 5 is a sectional view of the material conveying mold.

Wherein, 1—static mold, 2—rotary mold, 3—first material conveying channel, 4—second material conveying channel, 5—first sealing structure, 6—second sealing structure, 7—rotating support protrusion, 8—rotating support groove, 9—high-temperature gas sealing cavity, 10—L-shaped labyrinth sealing structure, 11—extruder, 13—worktable, 14—pressure accumulation storage bin 14 and 15—calender roll.

### DETAILED DESCRIPTION OF THE EMBODIMENTS

In the following, the technical solutions in the embodiments of the present disclosure will be clearly and completely described with reference to the drawings in the embodiments of the present disclosure. Obviously, the described embodiments are only a part of the embodiments of the present disclosure, but not all the embodiments thereof.

### Example 1

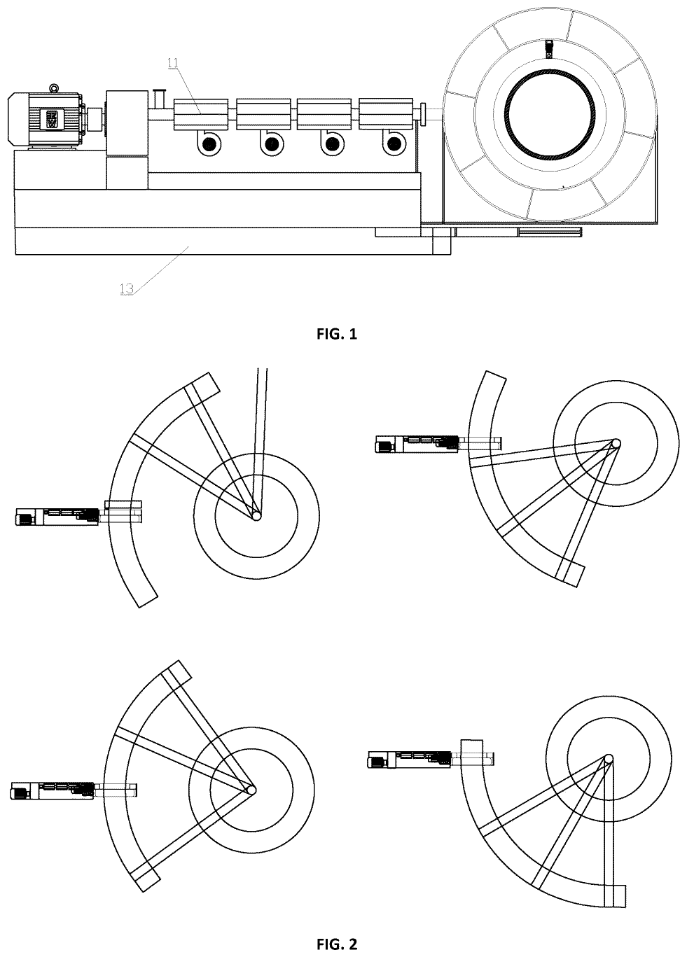

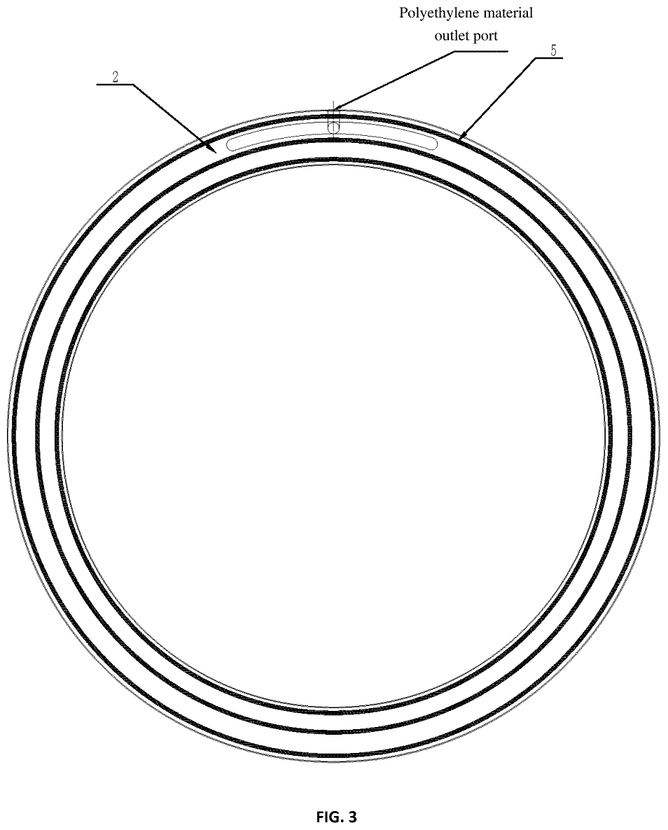

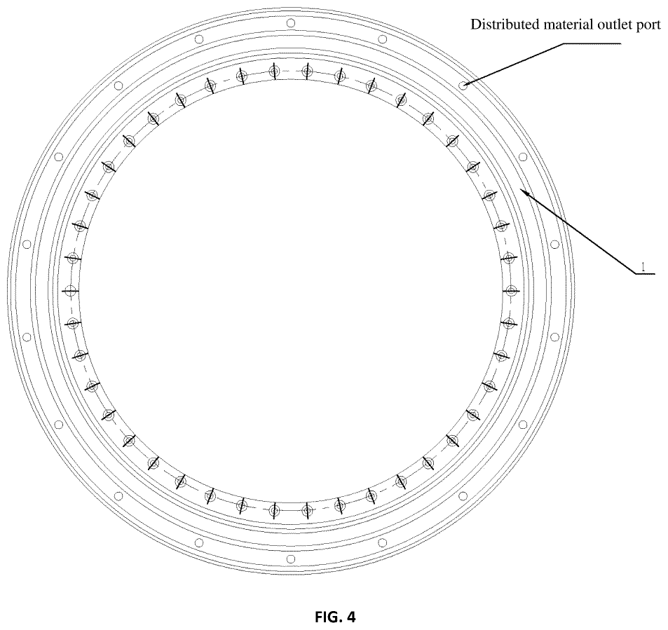

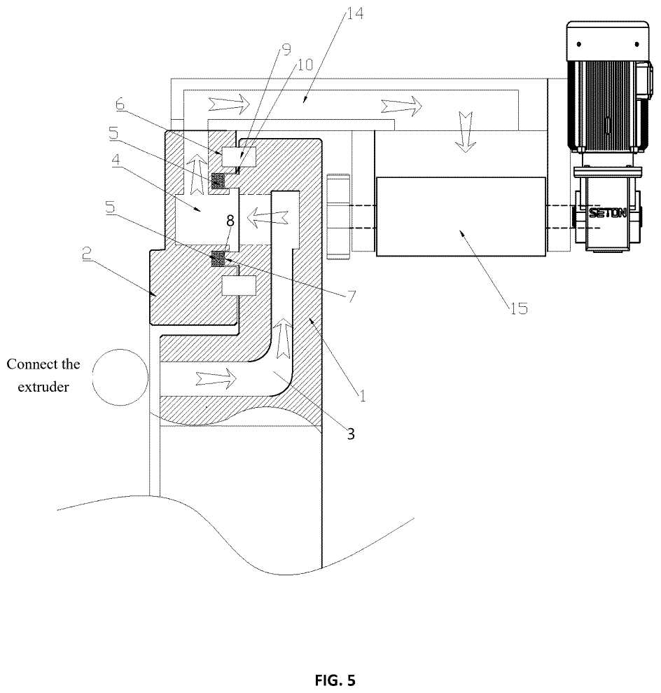

As shown in FIGS. 1 to 5, the present disclosure provides a equipment for preparing a polyethylene coating with a three-layer structure wound on a steel elbow, which includes a worktable 13 for supporting the elbow body and the extruder 11, the extruder 11 body is rotatably connected to the worktable 13 through a rotating mechanism, and the material output end of the extruder 11 is connected to the material inlet port of the material conveying mold for conveying molten polyethylene, the rotating mechanism is used to drive the extruder 11 and the material conveying mold at the end of the extruder 11 to rotate along the radian of the elbow body; the material outlet port of the second material conveying channel 4 is connected to the pressure accumulation storage bin 14, and the pressure accumulation storage bin 14 is fixedly connected to the rotary mold 2; the material output end of the pressure accumulation storage bin 14 is provided with a polyethylene rolling mechanism; the polyethylene rolling mechanism includes a connected rotating motor and the calender roll 15, and other structures refer to the contents disclosed in the patent CN115230111A. The present disclosure mainly relates to an improvement on the material conveying mold, which includes a static mold 1 and a rotary mold 2 which are rotationally connected, and the first material conveying channel 3 is formed in the static mold 1, the second material conveying channel 4 is formed in the rotary mold 2, a material outlet port of the first material conveying channel 3 is coaxially communicated with a material inlet port of the second material conveying channel 4, a first sealing structure 5 and a second sealing structure 6 are arranged at the communication position around the axis from inside to outside at intervals, the first sealing structure 5 is made of wear-resistant materials, and the second sealing structure 6 is sealed by high-temperature gas.

The polyethylene particles are heated to 230 degree Celsius by the extruder to be mixed under high pressure, the mixed polyethylene enters the static mold 1 through the first conveying channel 3, and enters the pressure accumulation storage bin 14 through the second material conveying channel 4 provided in the rotary mold 2. High-temperature and high-pressure polyethylene enters the rotary mold 2 through a distributed material inlet port provided on the static mold 1, enters the polyethylene calendering mechanism to form a required state through the polyethylene material outlet port provided on the rotary mold 2, and is wound on a workpiece. In order to ensure that the polyethylene in the high-temperature and high-pressure fluid state does not overflow, multiple sealing structures are provided on the static mold 1 and the rotary mold 2.

In the present disclosure, the static mold 1 is provided with a driving motor, which is connected to the rotary mold 2 through the transmission component and used to drive the rotary mold 2 to rotate relative to the static mold 1.

In the present disclosure, the transmission component adopts gear transmission, and the output shaft of the driving motor drives the driving gear to rotate, the driving gear drives the rotary mold 2 meshed with the driving gear to rotate.

### Example 2

Other structures are the same as in Example 1 except for the following.

In order to facilitate the flow of the molten polyethylene, the cross-sectional shapes of the first material conveying channel 3 and the second material conveying channel 4 are set to be L-shaped in the present disclosure.

As a specific implementation of a rotating structure, in the present disclosure, a rotating support protrusion 7 is provided on the outer end surface of the material outlet port of the first material conveying channel 3, and a rotating support groove 8 is provided on the outer end surface of the material inlet port of the second material conveying channel 4. The rotating support protrusion 7 can be inserted into the rotating support groove 8, and the first sealing structure 5 is provided inside the rotating support groove 8, forming a stable, wear-resistant and sealed rotating structure.

As a specific implementation of a rotating structure, in the present disclosure, the first gas containment cavity is provided on the outer end surface of the material outlet port of the first material conveying channel 3, which is located on the side of the rotating support protrusion 7, and the second gas containment cavity is provided on the outer end surface of the material inlet port of the second material conveying channel 4, which is located on the side of the rotating support groove 8. The first gas containment cavity and the second gas containment cavity are arranged relative to each other to form a high-temperature gas sealing cavity 9, which is connected to a high-temperature gas source.

### Example 3

Other structures are the same as in Example 1 and Example 2 except for the following.

In order to enhance the sealing performance, the L-shaped labyrinth sealing structure 10 is formed among the rotating support protrusion 7, the high-temperature gas sealing cavity 9 and the rotating support groove 8. Under the triple sealing structure, the sealing performance is ensured to avoid leakage of molten polyethylene.

### Example 4

Other structures are the same as in Example 1, Example 2 and Example 3 except for the following.

In order to timely know the temperature status and pressure status of the high-temperature gas sealing cavity 9, a temperature sensor is provided inside the high-temperature gas sealing cavity 9 in the present disclosure. The temperature sensor is provided inside the high-temperature gas sealing cavity 9. If the temperature detection value is greater than the preset temperature value, the input temperature of the high-temperature gas source is reduced. If the temperature detection value is less than the preset temperature value and the temperature detection valve is greater than 0.8 times of the preset temperature value, heating wires in the first gas containment cavity and the second gas containment cavity are started at this time, the temperature of the high-temperature gas source does not need to be increased, and the heating wires are utilized to rapidly compensate the temperature. If the temperature detection value is less than 0.8 times of the preset temperature value, the input temperature of the high-temperature gas source is increased.

The present disclosure also includes a gas pressure sensor provided inside the high-temperature gas sealing cavity 9. If the gas pressure detection value is greater than the preset gas pressure value, the input amount of the high-temperature gas source is reduced. If the gas pressure detection value is less than the preset gas pressure value and the gas pressure detection value is greater than 0.9 times of the preset gas pressure value, heating wires in the first gas containment cavity and the second gas containment cavity are started. At this time, the input amount of the high-temperature gas source does not need to be increased, the heating wires are utilized to rapidly compensate the temperature. As the temperature is increased, the gas pressure in the high-temperature gas sealing cavity 9 is also changed. If the gas pressure detection value is less than 0.9 times of the preset temperature value, the input amount of the high-temperature gas source is increased.

Finally, it should be noted that the above embodiments are only used to illustrate the technical solutions of the present disclosure and not to limit it. Although the present disclosure has been described in detail with reference to the preferred embodiments, those skilled in the art should understand that modifications or equivalent substitutions can still be made to the present disclosure, and these modifications or equivalent substitutions cannot make the modified technical solution deviate from the spirit and scope of the present disclosure.

1. Equipment for preparing a polyethylene coating with a three-layer structure wound on a steel elbow, comprising: a material conveying mold for conveying molten polyethylene, the material conveying mold comprises a static mold and a rotary mold which are rotationally connected, and a first material conveying channel is formed in the static mold, a second material conveying channel is formed in the rotary mold, a material outlet port of the first material conveying channel is coaxially communicated with a material inlet port of the second material conveying channel, a first sealing structure and a second sealing structure are arranged at a communication position around an axis from inside to outside at intervals, the first sealing structure is made of wear-resistant materials, and the second sealing structure is sealed by high-temperature gas;
a rotating support protrusion is provided on an outer end surface of the material outlet port of the first material conveying channel, and a rotating support groove is provided on an outer end surface of the material inlet port of the second material conveying channel; the rotating support protrusion can be inserted into the rotating support groove, and the first sealing structure is provided inside the rotating support groove;
a first gas containment cavity is provided on an outer end surface of the material outlet port of the first material conveying channel, and a second gas containment cavity is provided on an outer end surface of the material inlet port of the second material conveying channel; the first gas containment cavity and the second gas containment cavity are arranged relative to each other to form a high-temperature gas sealing cavity, which is connected to a high-temperature gas source;
a temperature sensor is provided inside the high-temperature gas sealing cavity; if a temperature detection value is greater than a preset temperature value, the a temperature of the high-temperature gas source is reduced; if a temperature detection value is less than a preset temperature value and the temperature detection valve is greater than 0.8 times of the preset temperature value, heating wires in the first gas containment cavity and the second gas containment cavity are started; if a temperature detection value is less than 0.8 times of a preset temperature value, an input temperature of the high-temperature gas source is increased;
a gas pressure sensor is provided inside the high-temperature gas sealing cavity; if a gas pressure detection value is greater than a preset gas pressure value, an input amount of the high-temperature gas source is reduced; if a gas pressure detection value is less than a preset gas pressure value and the gas pressure detection value is greater than 0.9 times of the preset gas pressure value, heating wires in the first gas containment cavity and the second gas containment cavity are started; if a gas pressure detection value is less than 0.9 times of a preset temperature value, an input amount of the high-temperature gas source is increased.

2. The equipment for preparing a polyethylene coating with a three-layer structure wound on a steel elbow according to claim 1, wherein the static mold is provided with a driving motor, which is connected to the rotary mold through a transmission component and used to drive the rotary mold to rotate relative to the static mold.

3. The equipment for preparing a polyethylene coating with a three-layer structure wound on a steel elbow according to claim 2, wherein the transmission component adopts gear transmission, and an output shaft of the driving motor drives a driving gear to rotate, the driving gear drives the rotary mold meshed with the driving gear to rotate.

4. The equipment for preparing a polyethylene coating with a three-layer structure wound on a steel elbow according to claim 1, wherein an L-shaped labyrinth sealing structure is formed among the rotating support protrusion, the high-temperature gas sealing cavity and the rotating support groove.

5. The equipment for preparing a polyethylene coating with a three-layer structure wound on a steel elbow according to claim 1, wherein the equipment further comprises a worktable for supporting the elbow body and an extruder, wherein the extruder body is rotatably connected to the worktable through a rotating mechanism, and a material output end of the extruder is connected to a material inlet port of the first material conveying channel, the rotating mechanism is used to drive the extruder and the material conveying mold at the end of the extruder to rotate along radian of the elbow body; the material outlet port of the second material conveying channel is connected to a pressure accumulation storage bin, and the pressure accumulation storage bin is fixedly connected to the rotary mold; an material output end of the pressure accumulation storage bin is provided with a polyethylene rolling mechanism; the polyethylene rolling mechanism comprises a connected rotating motor and a calender roll.

6. The equipment for preparing a polyethylene coating with a three-layer structure wound on a steel elbow according to claim 3, wherein an L-shaped labyrinth sealing structure is formed among the rotating support protrusion, the high-temperature gas sealing cavity and the rotating support groove.
